(19) United States
(12) Patent Application Publication
(10) Pub. No.: US 2008/0161450 A1
(43) Pub. Date: Jul. 3, 2008

(54) CELLULOSE/PLASTIC COMPOSITES

(76) Inventors: Bernhard Bartnick, Monheim (DE); Peter Daute, Beverstedt (DE); Alfred Westfechtel, Hilden (DE)

Correspondence Address: COGNIS CORPORATION;PATENT DEPARTMENT, 300 BROOKSIDE AVENUE, AMBLER, PA, 19002, US

(21) Appl. No.: 11/876,842

(22) Filed: Oct. 23, 2007

(30) Foreign Application Priority Data
Oct. 31, 2006 (EP) 06022671.9

(51) Int. Cl. C08F 34/02; C08L 1/00

(52) U.S. Cl. 524/35; 526/271; 528/354

(57) ABSTRACT

Reaction products of maleic anhydride and/or itaconic anhydride with one or more olefinically-unsaturated fatty compounds as compatibilizers for cellulose/plastic composites.

### RELATED APPLICATIONS

This application claims priority from EP 07022671.9 filed Oct. 31, 2006; the entire contents of which are incorporated herein by reference.

### FIELD OF THE INVENTION

This invention relates generally to composite materials and, more particularly, to a special cellulose/plastic composite and to the use of MA adducts with unsaturated fatty compounds as compatibilizers for cellulose/plastic composites.

### PRIOR ART

The term “cellulose” in the specification—either in the discussion of the prior art or in the description of the invention—is meant as an abbreviated form of “cellulose-containing native polymers”.

So-called “cellulose/plastic composites” have acquired increasing significance in recent years. These composites contain cellulose, for example, wood, and one or more plastics, for example polyvinyl chloride (PVC), as their basic materials. In addition, they generally contain one or more additives which are intended to make both the materials mentioned compatible (processable) with one another, ensuring that a uniform, largely homogeneous composite material is formed. Such composite materials may also be interpreted as plastics which contain cellulose as a filler or reinforcing medium, with cellulose particles embedded in a plastic matrix. The compatibility of cellulose-containing native polymers and plastic in the composite material is ensured by one or more suitable additives which provide for good cohesion or crosslinking of the various materials. Such one or more additives are occasionally referred to as crosslinkers rather than compatibilizers.

WO 2006/084 163 A2 (DuPont) describes cellulose/plastic composites where a substance obtainable by reacting polyvinyl butyral with a special polymer is used as the compatibilizer.

DE 10015913 A1 (Henkel) describes the use of adducts of two components A and B and subsequent radical or peroxidative modification of the primary reaction product as tackifiers or binders for adhesives. Reaction products of unsaturated triglycerides with maleic anhydride (MA), for example a reaction product of soybean oil with MA, are mentioned as intermediates. However, these intermediates are subjected to subsequent modification and the end product is used as a tackifier for adhesives. There is no mention of the use of the intermediates as compatibilizers for cellulose/plastic composites.

Laurent M. Matuana et al. (Polymer Composites 1998, Vol. 19, No. 4, pp. 446-551) describe their investigation of various “Coupling agents” (i.e. compatibilizers) for PVC/wood composites. They found that certain aminosilanes (gamma-aminopropyl triethoxysilane) have favorable properties in this regard, whereas other compounds (dichlorodiethylsilane, phthalic anhydride and maleinized polypropylene) are ineffective.

### BRIEF SUMMARY OF THE INVENTION

The objective of the present invention was to provide compatibilizers for cellulose/plastic composites, preferably for wood/polyvinyl chloride composites.

According to the invention, this objective has been met by reaction products of maleic anhydride (MA) and/or itaconic anhydride (IA), MA being preferred to IA, with olefinically-unsaturated fatty compounds. In the production of these reaction products, one or more C═C double bonds of the olefinically-unsaturated fatty compounds is/are allowed to react with the C═C double bond of the MA and/or the IA. One molecule of MA or IA is consumed per each reaction of the C═C double bond of the olefinically-unsaturated fatty compounds.

The present invention relates to the use of reaction products of maleic anhydride and/or itaconic anhydride with olefinically unsaturated fatty compounds as compatibilizers for cellulose/plastic composites.

Basically, there is no limit to the nature of the olefinically unsaturated fatty compounds and, in principle, any fatty compounds known to the practitioner which contain one or more C═C double bonds per molecule may be used. Fatty compounds in the present context are understood to be both naturally-occurring fats and oils and derivatives of them. Well-known derivatives include fatty acids, fatty alcohols and esters of fatty acids and mono- or polyhydric alcohols containing 1 to 24 carbon atoms. The esters of fatty acids with polyols from the group consisting of glycerol, trimethylolpropane, glycerol, dipentaerythritol and pentaerythritol are particularly preferred. These esters preferably have an iodine value/number of 10 to 250. Mono-, di- and triglycerides of C₈₋₂₄ fatty acids which have iodine values of 30 to 230 are most particularly preferred. Examples of particularly suitable triglycerides are sunflower oil from old and/or new plants, soybean oil, fish oil, tallow, rapeseed oil, tall oil, thistle oil, peanut oil and linseed oil.

The compatibilizers to be used in accordance with the invention are produced by reaction of the olefinically-unsaturated fatty compounds with maleic anhydride and/or itaconic anhydride, preferably at slightly elevated temperature.

As already mentioned (see above), the term “cellulose” is used in the present specification as a shortened form of “cellulose-containing native polymers”, and is not limited, with suitable celluloses including, for example, wood of any type and origin, cotton, coconut, kapok, paper, grasses and halms such as, for example, rice, bamboo, bast, jute, flax, hemp, linen, reed, but preferably originates from wood. It may assume various forms and particle sizes, for example, particles, chips, fine powders or fibers. In one embodiment, particles with a particle size of 5 to 250 micrometers are used.

Basically, there are also no limits to the nature of the plastics used herein. In principle, any known homopolymers and copolymers may be used. Examples of suitable plastics include polyethylene, for example, HDPE, LDPE, LLDPE, UHMWPE, ULDPE, copolymers of ethylene with other monomers, polypropylene, ethylene/propylene copolymers, terpolymers, such as ethylene/propylene/diene, and chlorine-containing polymers.

In one embodiment, thermoplastics are used as the plastic.

In a preferred embodiment, chlorine-containing polymers or recyclates thereof are used as the plastic. Examples of such chlorine-containing polymers or recyclates thereof to be stabilized are polymers of vinyl chloride; vinyl resins containing vinyl chloride units in their structure, such as copolymers of vinyl chloride and vinyl esters of aliphatic acids, more particularly vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; after-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether and the like; polymers of vinylidene chloride and copolymers thereof with vinyl chloride and other polymerizable compounds; polymers of vinyl chloroacetate and dichlorodivinyl ether; chlorinated polymers of vinyl acetate, chlorinated polymeric ethers of acrylic acid and alpha-substituted acrylic acid; polymers of chlorinated styrenes, for example dichlorostyrene; chlorinated polymers of ethylene; polymers and after-chlorinated polymers of chlorobutadiene and copolymers thereof with vinyl chloride; and mixtures of the polymers mentioned with one another or with other polymerizable compounds.

Graft polymers of PVC with EVA, ABS and MBS are also included. Other preferred substrates are mixtures of the above-mentioned homo- and copolymers, more particularly vinyl chloride homopolymers, with other thermoplastic and/or elastomeric polymers, more particularly blends with ABS, MBS, NBR, SAN, EVA, CPE, MBAS, PMA, PMMA, EPDM and polylactones.

Other preferred polymers are suspension and bulk polymers and also emulsion polymers.

Polyvinyl chloride, more particularly as a suspension polymer and bulk polymer, is particularly preferred as the chlorine-containing polymer.

In the context of the present invention, PVC also includes copolymers or graft polymers of PVC with polymerizable compounds, such as acrylonitrile, vinyl acetate or ABS, in the form of suspension, bulk or emulsion polymers. PVC homopolymer—also in combination with polyacrylates—is preferred.

Recyclates of chlorine-containing polymers are also suitable, such recyclates of the polymers described in detail above which have been damaged by processing, use or storage. PVC recyclate is particularly preferred. The recyclates may also contain small quantities of foreign materials such as, for example, paper, pigments and adhesives which are often difficult to remove. These foreign materials may also originate from contact with various substances during use or reprocessing, including, for example, fuel residues, paints, metal traces and initiator residues.

The present invention also relates to cellulose/plastic composites containing (a) cellulose, more particularly wood, (b) a plastic, more particularly polyvinyl chloride and (c) a compatibilizer obtainable by reaction of maleic anhydride and/or itaconic anhydride with olefinically-unsaturated fats.

In one embodiment, the composite contains the components mentioned in the following quantities: 10-70% (a), 10-90% (b) and 0.1-20% (c).

In another embodiment, the composite contains the components mentioned in the following quantities: 30-60% (a), 40-80% (b) and 0.3-10% (c).

In another embodiment, the composite contains the components mentioned in the following quantities: 40-5% (a), 35-50% (b) and 0.5-55% (c).

The present invention also relates to a process for the production of cellulose/plastic composites, characterized in that (a) cellulose, more particularly wood, (b) a plastic, more particularly polyvinyl chloride, and (c) a compatibilizer obtainable by reaction of maleic anhydride and/or itaconic anhydride with one or more olefinically-unsaturated fatty compounds are combined, mixed together, preferably at a temperature in the range from 50° to 130° C., and the dry blend obtained is subsequently heated to a temperature above the melting temperature of the plastic, subjected to the desired shaping process and allowed to cool.

One embodiment of this process is characterized by the use of a premix of components (b) and (c). In this embodiment, component (a) and, in a parallel step, the pre-mixed components (b) and (c) are fed into the extruder. They are then heated in the extruder to a temperature above the melting temperature of the plastic, subjected to the desired shaping process and allowed to cool.

### EXAMPLES

1. Substances used

| | |
|---|---|
| EVIPOL ™ SH 5730 | PVC (from Ineos Chlor Vinyls) |
| Wood powder 50-100 microns | Specially produced wood meal (from |
| | Codip, Holland) |
| Stabiol CZ 2001/1 | CaZn stabilizer compound (from Reagens, |
| | Lohne) |
| EDENOL ® D 81 | Epoxidized soybean oil (from Cognis |
| | Oleochemicals) |

### 2. Production of the Compatibilizers According to the Invention

### Example 1

### 10% MA Added onto Soybean Oil

1,000 g refined soybean oil were dried at up to 110° C. in a water jet vacuum and 100 g MA were added under nitrogen. The mixture was heated for 3 hours at 220° C. A clear, brown-yellow, slightly viscous liquid was obtained. Properties: viscosity (Brookfield, spindle 21, 50 r.p.m., 40° C.)=181 cps

### 3. Production of Dry Blends

A dry blend was produced in a HENSCHEL™ mixer from PVC powder and various additives (quantity of material=3 kg, heating temperature=120° C., subsequent cooling). The compositions (formulations C1 and E2) are listed in Table 1 below (quantities in parts by weight). The additives used combine both with the wood and with the PVC.

TABLE 1

| Example: | C1 | E2 |
|---|---|---|
| PVC EVIPOL SH 5730 | 100 | 100 |
| Wood powder 50-100 microns | 100 | 100 |
| Stabiol CZ 2001/1 | 1.5 | 1.5 |
| EDENOL ® D 81 | 10 | 10 |
| Substance of Example 1 (soybean oil + 10% MA) | — | 10 |

Formulation E2 corresponds to the invention. Formulation C1 is intended for comparison.

### 4. Performance Tests, Production of Rolled Sheets

The dry blends were rolled out into a sheet on Collin GmbH laboratory rolls (parameters of the rolls: rotational speed 15 r.p.m., temperature 190° C.). The surfaces of the sheets were examined by optical microscope as a measure of the dispersion effectiveness.

### Optical Assessment of the Sheet Surface:

C1: coarsely structured, no gloss
E2: coarsely structured, high gloss

The compatibilizers according to the invention showed crosslinking of the MA/at adduct between wood and plastic and, hence, greatly improved distribution of the filler wood in the wood/fiber composite, more especially on the surface of the sheet of Example E2.

### 5. Production of Pressed Sheets and Determination of Notched Impact Strength

Pressed sheets were produced from the rolled sheets produced as described in Section 4. To this end, the plasticized rolled sheet material was placed in a chromium-plated iron frame and pressed for 4.5 minutes under a pressure of 200 bar and at a temperature of 170° C. The double V notched impact strength of the pressed sheets (400 mm×40 mm) was then tested to DIN EN 179.

The notched impact test was carried out on a standardized test specimen using a pendulum impact tester (23° C./50% rel. air humidity, 3 days). The deformation energy up to fracture was measured. The results are an indication of the toughness, brittleness and homogeneity of the material. They are set out in Table 2.

TABLE 2

| | Residual | | Impact | Impact | |
|---|---|---|---|---|---|
| | width | Height | energy | strength | Fracture |
| Formulation | [mm] | [mm] | [mJ] | [mJ/mm²] | type |
| C1/1 | 20.10 | 2.16 | 132 | 3.0 | 1 |
| C1/2 | 20.07 | 2.12 | 154 | 3.6 | 1 |
| C1/3 | 20.18 | 2.05 | 176 | 4.3 | 1 |
| C1/4 | 20.14 | 2.12 | 146 | 3.4 | 1 |
| C1/5 | 20.17 | 2.04 | 141 | 3.4 | 1 |
| C1/6 | 20.10 | 2.13 | 152 | 3.6 | 1 |
| Mean | 20.13 | 2.10 | 150 | 3.6 | 1 |
| value: | | | | | |
| E2/1 | 20.12 | 2.20 | 183 | 4.1 | |
| E2/2 | 20.16 | 2.07 | 181 | 4.3 | 1 |
| E2/3 | 20.11 | 2.15 | 206 | 4.8 | 1 |
| E2/4 | 20.14 | 2.14 | 170 | 3.9 | 1 |
| E2/5 | 20.17 | 2.12 | 182 | 4.3 | 1 |
| E2/6 | 20.19 | 2.07 | 172 | 4.1 | 1 |
| Mean | 20.15 | 2.13 | 182 | 4.3 | 1 |
| value: | | | | | |

Fracture type:
1 = complete fracture, 2 = hinge fracture, 3 = partial fracture

The MA/fat adducts according to the invention led to greatly improved fracture behavior of the wood/plastic composite test specimens as reflected in the impact energy of 150 mJ without the MA/fat adduct and 182 mJ with the MA/fat adduct and in the impact strength of 3.6 mJ/mm without the MA/fat adduct and 4.3 mJ/mm with the MA/fat adduct.

### 6. Preparation of the Test Specimens for Measuring Tensile Strength

Test bars measuring 10 cm×2 cm were cut from the pressed sheets produced as described in Section 5. The test bars were then clamped into a tensile testing machine and slowly subjected to an increasing load until they broke (DIN 53455). The forces applied were documented and are shown in Table 3.

TABLE 3

| | | Tensile | | |
|---|---|---|---|---|
| | Max. | strength | Elongation at | Ultimate tensile |
| Formulation | force N | N/mm² | break % | strength N/mm² |
| C1 | 761 | 19.0 | 9.6 | 19 |
| E2 | 1103 | 27.6 | 11.1 | 27.6 |

The fat/MA adducts according to the invention lead to greatly improved ultimate tensile strength of the wood/plastic composite test specimens.

### 7. Preparation of the Test Specimens for Measuring Surface Gloss

Uniform 6 cm×6 cm test strips were cut from the strips produced as described in Section 4. Gloss was measured by reflection of the light beam directed onto a surface. The gloss value may be interpreted as a correlation value for smoothness measurement. In other words, the smoother the surface, the better the distribution of the filler, wood, in the plastic mixture. The gloss measurement results are set out in Table 4.

TABLE 4

| Formulation | Front | Back |
|---|---|---|
| C1 | 2.6 | 2.8 |
| E2 | 3.3 | 3.4 |

The fat/MA adducts+catalyst according to the invention led to greatly improved gloss of the wood/plastic composite surfaces and thus showed a distinctly improved distribution and dispersion of the filler, wood, in the plastic mixture.

1. A compatibilizer for cellulose/plastic composites comprising reaction products of maleic anhydride and/or itaconic anhydride with one or more olefinically-unsaturated fatty compounds.

2. A compatibilizer according to claim 1, characterized in that esters of fatty acids with polyols from the group consisting of glycol, trimethylolpropane, glycerol, dipentaerythritol and pentaerythritol are used as the olefinically-unsaturated fatty compounds in production of the compatibilizer, with the proviso that these esters have an iodine value of 10 to 250.

3. A compatibilizer according to claim 1, characterized in that triglycerides of C₈₋₂₄ fatty acids are used as the one or more olefinically-unsaturated fatty compounds in production of the compatibilizer, with the proviso that these esters have an iodine value of 30 to 230.

4. A oompatibilizer according to claim 3, characterized in that the one or more olefinically-unsaturated fatty compounds used in production of the compatibilizer are selected from the group consisting of sunflower oil from old and/or new plants, soybean oil, fish oil, tallow, rapeseed oil, tall oil, thistle oil, peanut oil and linseed oil.

5. A compatibilizer according to claim 1, characterized in that wood is used as cellulose in the cellulose/plastic composite.

6. A compatibilizer according to claim 5, characterized in that the wood is used in the form of particles, chips, fine powders or fibers.

7. A compatibilizer according to claim 1 characterized in that thermoplastics are used as plastic in the cellulose/plastic composites.

8. A compatibilizer according to claim 1, characterized in that polyvinyl chloride is used as plastic in the cellulose/plastic composite.

9. Cellulose/plastic composites containing (a) cellulose-containing native polymer, (b) a plastic, and (c) a compatibilizer obtainable by reaction of maleic anhydride, itaconic anhydride, or a mixture thereof with one or more olefinically-unsaturated fatty compounds.

10. A process for the production of cellulose-containing native polymer/plastic composites, characterized in that (a) cellulose-containing native polymer, (b) a plastic, and (c) a compatibilizer obtainable by reaction of maleic anhydride, itaconic anhydride, or a mixture thereof with one or more olefinically-unsaturated fatty compounds are combined, mixed together, preferably at a temperature of from 50° to 130° C., resulting in a dry blend that is subsequently heated to a temperature above the melting temperature of the plastic, subjected to the desired shaping process and allowed to cool.

11. A process according to claim 10, characterized in that a premix of components (b) and (c) is created then combined with component (a).
